(19) United States
(12) Patent Application Publication
(10) Pub. No.: US 2025/0184076 A1
(43) Pub. Date: Jun. 5, 2025

(54) DYNAMIC ANTENNA PORT ADAPTATION

(71) Applicant: QUALCOMM Incorporated, San Diego, CA (US)

(72) Inventors: Hung Dinh LY, San Diego, CA (US); Yu ZHANG, San Diego, CA (US); Kexin XIAO, Shanghai (CN)

(21) Appl. No.: 18/844,370

(22) PCT Filed: Apr. 30, 2022
(86) PCT No.: PCT/CN2022/090829

§ 371 Date: Sep. 5, 2024

(51) Int. Cl. H04L 5/00; H01Q 1/24; H04W 24/10

(52) U.S. Cl. CPC H04L 5/0051; H04W 24/10; H01Q 1/246

(57) ABSTRACT

A method for wireless communication by a user equipment (UE) includes receiving a resource configuration indicating a new channel state information-reference signal (CSI-RS) resource group that includes CSI-RS resources from one or more existing CSI-RS resource groups in a CSI-RS resource set associated with a CSI measurement report configuration. The new CSI-RS resource group may be associated with a new group of CSI-RS ports that includes CSI-RS ports associated with the one or more CSI-RS resource groups. The method also includes receiving one or more CSI-RSs associated with the CSI-RS resources within the new CSI-RS resource group, transmitting a CSI measurement report based on receiving the one or more CSI-RSs; and receiving, from the network node based on transmitting the CSI measurement report, a downlink transmission via one or more antenna panels, a quantity of the one or more antenna panels being based on a cell load indicated in the CSI measurement report.

### FIELD OF THE DISCLOSURE

The present disclosure relates generally to wireless communications, and more specifically to dynamically adapting antenna ports at a network node.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (for example, bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation.

Some networks may use massive-MIMO systems to improve network throughput and efficiency. In comparison to conventional MIMO systems, massive-MIMO systems increase a number of antennas at a network node. Specifically, a network node may include multiple co-located antenna panels, in which each antenna panel has multiple antenna ports. Additionally, each antenna panel may include a group of power amplifiers and an antenna subsystem. Therefore, to improve power use, the network node may dynamically deactivate one or more antenna panels based on a cell load.

### SUMMARY

In one aspect of the present disclosure, a method for wireless communication by a UE includes receiving, from a network node, a resource configuration indicating a new channel state information-reference signal (CSI-RS) resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more existing CSI-RS resource groups. The method further includes receiving, from the network node, one or more CSI-RSs associated with the CSI-RS resources within the new CSI-RS resource group. The method still further includes transmitting a CSI measurement report based on receiving the one or more CSI-RSs. The method also includes receiving, from the network node based on transmitting the CSI measurement report, a downlink transmission via one or more antenna panels, a quantity of the one or more antenna panels being based on a cell load indicated in the CSI measurement report.

Another aspect of the present disclosure is directed to an apparatus including means for receiving, from a network node, a resource configuration indicating a new CSI-RS resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more existing CSI-RS resource groups. The apparatus further includes means for receiving, from the network node, one or more CSI-RSs associated with the CSI-RS resources within the new CSI-RS resource group. The apparatus still further includes means for transmitting a CSI measurement report based on receiving the one or more CSI-RSs. The apparatus also includes means for receiving, from the network node based on transmitting the CSI measurement report, a downlink transmission via one or more antenna panels, a quantity of the one or more antenna panels being based on a cell load indicated in the CSI measurement report.

In another aspect of the present disclosure, a non-transitory computer-readable medium with non-transitory program code recorded thereon is disclosed. The program code is executed by a processor and includes program code to receive, from a network node, a resource configuration indicating a new CSI-RS resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more existing CSI-RS resource groups. The program code further includes program code to receive, from the network node, one or more CSI-RSs associated with the CSI-RS resources within the new CSI-RS resource group. The program code still further includes program code to transmit a CSI measurement report based on receiving the one or more CSI-RSs. The program code also includes program code to receive, from the network node based on transmitting the CSI measurement report, a downlink transmission via one or more antenna panels, a quantity of the one or more antenna panels being based on a cell load indicated in the CSI measurement report.

Another aspect of the present disclosure is directed to an apparatus for wireless communications at a UE. The apparatus includes a processor, and a memory coupled with the processor and storing instructions operable, when executed by the processor, to cause the apparatus to receive, from a network node, a resource configuration indicating a new CSI-RS resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more existing CSI-RS resource groups. Execution of the instructions further cause the apparatus to receive, from the network node, one or more CSI-RSs associated with the CSI-RS resources within the new CSI-RS resource group. Execution of the instructions also cause the apparatus to transmit a CSI measurement report based on receiving the one or more CSI-RSs. Execution of the instructions still further cause the apparatus to receive, from the network node based on transmitting the CSI measurement report, a downlink transmission via one or more antenna panels, a quantity of the one or more antenna panels being based on a cell load indicated in the CSI measurement report.

In one aspect of the present disclosure, a method for wireless communication by a network node includes transmitting a resource configuration indicating a new CSI-RS resource group that includes CSI-RS resources from one or more existing CSI-RS resource groups in a CSI-RS resource set associated with a CSI measurement report configuration, the new CSI-RS resource group may be associated with a new group of CSI-RS ports that includes CSI-RS ports associated with the one or more existing CSI-RS resource groups. The method further includes transmitting one or more CSI-RSs associated with the CSI-RS resources within the new CSI-RS resource group. The method still further includes receiving a CSI measurement report based on transmitting the one or more CSI-RSs. The method also includes adjusting, based on receiving the CSI measurement report, a number of active antenna panels in a group of active antenna panels may be associated with the network node.

Another aspect of the present disclosure is directed to an apparatus including means for transmitting a resource configuration indicating a new CSI-RS resource group that includes CSI-RS resources from one or more existing CSI-RS resource groups in a CSI-RS resource set associated with a CSI measurement report configuration, the new CSI-RS resource group may be associated with a new group of CSI-RS ports that includes CSI-RS ports associated with the one or more existing CSI-RS resource groups. The apparatus further includes means for transmitting one or more CSI-RSs associated with the CSI-RS resources within the new CSI-RS resource group. The apparatus still further includes means for receiving a CSI measurement report based on transmitting the one or more CSI-RSs. The apparatus also includes means for adjusting, based on receiving the CSI measurement report, a number of active antenna panels in a group of active antenna panels may be associated with the network node.

In another aspect of the present disclosure, a non-transitory computer- readable medium with non-transitory program code recorded thereon is disclosed. The program code is executed by a processor and includes program code to transmit a resource configuration indicating a new CSI-RS resource group that includes CSI-RS resources from one or more existing CSI-RS resource groups in a CSI-RS resource set associated with a CSI measurement report configuration, the new CSI-RS resource group may be associated with a new group of CSI-RS ports that includes CSI-RS ports associated with the one or more existing CSI-RS resource groups. The program code further includes program code to transmit one or more CSI-RSs associated with the CSI-RS resources within the new CSI-RS resource group. The program code still further includes program code to receive a CSI measurement report based on transmitting the one or more CSI-RSs. The program code also includes program code to adjust, based on receiving the CSI measurement report, a number of active antenna panels in a group of active antenna panels may be associated with the network node.

Another aspect of the present disclosure is directed to an apparatus for wireless communications at a network node. The apparatus includes a processor, and a memory coupled with the processor and storing instructions operable, when executed by the processor, to cause the apparatus to transmit a resource configuration indicating a new CSI-RS resource group that includes CSI-RS resources from one or more existing CSI-RS resource groups in a CSI-RS resource set associated with a CSI measurement report configuration, the new CSI-RS resource group may be associated with a new group of CSI-RS ports that includes CSI-RS ports associated with the one or more existing CSI-RS resource groups. Execution of the instructions also cause the apparatus to transmit one or more CSI-RSs associated with the CSI-RS resources within the new CSI-RS resource group. Execution of the instructions further cause the apparatus to receive a CSI measurement report based on transmitting the one or more CSI-RSs. Execution of the instructions still further cause the apparatus to adjust, based on receiving the CSI measurement report, a number of active antenna panels in a group of active antenna panels may be associated with the network node.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying Figures. Each of the Figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 shows a diagram illustrating an example disaggregated base station architecture.

FIG. 4A is a block diagram illustrating an example of channel state information (CSI)-reference signal (RS) resource groups associated with a CSI-RS resource set, in accordance with various aspects of the present disclosure.

FIG. 4B and 4C are block diagrams illustrating examples of new CSI-RS resource groups, in accordance with various aspects of the present disclosure.

FIG. 5 is a block diagram illustrating an example wireless communication device that supports forming a new CSI-RS resource group, in accordance with some aspects of the present disclosure.

FIG. 6 is a flow diagram illustrating an example process performed by a UE, in accordance with some aspects of the present disclosure.

FIG. 7 is a block diagram illustrating an example wireless communication device that supports forming a new CSI-RS resource group, in accordance with aspects of the present disclosure.

FIG. 8 is a flow diagram illustrating an example of a process performed by a wireless device, in accordance with some aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Some networks may use massive-multiple-output (MIMO) systems to improve network throughput and efficiency. In comparison to conventional MIMO systems, massive-MIMO systems increase a number of antennas at a network node. Specifically, a network node may include multiple co-located antenna panels, and each antenna panel may have multiple antenna ports. Additionally, each antenna panel may include a group of power amplifiers and an antenna subsystem. Therefore, the massive-MIMO system may increase power consumption at a network node. The increased power consumption may increase costs (for example, monetary costs) associated with operating a wireless network. Furthermore, the increased power consumption may limit opportunities for expanding network coverage because it may be difficult to increase a number of network nodes in view of the costs associated with the high power consumption.

In some examples, to reduce energy consumption, the network node may dynamically adjust a number of active antenna panels in a group of active antenna panels based on a network load. In such examples, the network node may maintain an active state for one or more active antenna panels from the group of active antenna panels when the network load is less than a threshold. Additionally, the network node may deactivate one or more active antenna panels, subpanels, or antenna ports from the group of active antenna panels when the network load is less than a threshold. The network load may be determined based on channel state information (CSI)-reference signal (RS) measurements indicated in a CSI measurement report. Each of the one or more antenna panels that remains active is associated with a CSI-RS resource group that generated the CSI-RS measurements indicated in the CSI measurement report.

In conventional systems, the network node may be limited to deactivating antenna panels in accordance with existing CSI-RS resource groups in a CSI-RS resource set. In such examples, it may be difficult for the network node to control a level of granularity associated with dynamically adjusting a number of active antenna panels. In some such examples, the network node may not be able to dynamically adjust a number of active subpanels or antenna ports in the group of active antenna panels. It may be desirable to improve power saving techniques at a network node that uses a multi-panel antenna by providing more granularity in the process for dynamically adjusting the number of active antenna panels in the group of active antenna panels.

Aspects of the present disclosure generally relate to wireless communication, and specifically to techniques and apparatuses for forming a new CSI-RS resource group that includes CSI-RS resources from one or more existing CSI-RS resource groups and adjusting a number of active antenna panels based on a CSI measurement report associated with the new CSI-RS resource group. In some examples, a network node may transmit, to a user equipment (UE), a resource configuration indicating the new CSI-RS resource group that includes CSI-RS resources from one or more existing CSI-RS resource groups. The one or more existing CSI-RS resource groups are selected from a CSI-RS resource set associated with a CSI measurement report configuration. The new CSI-RS resource group may be associated with a new group of CSI-RS ports that includes CSI-RS ports associated with the one or more existing CSI-RS resource groups. In some examples, the new CSI-RS resource group aggregates resources from two or more existing CSI-RS resource groups. In other examples, the new CSI-RS resource group includes a subset of resources from one existing CSI-RS resource group. The network node may then transmit one or more CSI-RSs associated with CSI resources within the new CSI-RS resource group. The network node may then receive a CSI measurement report based on transmitting the one or more CSI-RSs. The CSI measurement report may indicate CSI measurements performed via the new CSI-RS resource group.

After receiving the CSI measurement report, the network node may adjust a number of active antenna panels from a group of active antenna panels associated with the network node. In some examples, one or more active antenna panels from the group of active antenna panels are associated with the new group of CSI-RS ports. In some such examples, the network node may maintain an active state of each of the one or more active antenna panels associated with the new group of CSI-RS ports based on the CSI measurement report indicating that a cell load satisfies a load condition. In such examples, the network node may also disable or deactivate each active antenna panel of the group of active antenna panels that is not associated with the new group of CSI-RS ports based on the CSI measurement report indicating that the cell load satisfies the load condition.

Particular aspects of the subject matter described in this disclosure may be implemented to realize one or more of the following potential advantages. In some examples, the described techniques may improve power savings at a network node that uses a multi-panel antenna. In some such examples, by specifying a new CSI-RS resource group from one or more existing CSI-RS resource groups, aspects of the present disclosure may improve a granularity at which the one or more antenna panels are deactivated. The improved granularity may increase an amount of power that may be saved because the network node may have more flexibility to deactivate one or more antenna panels, subpanels, or antenna ports.

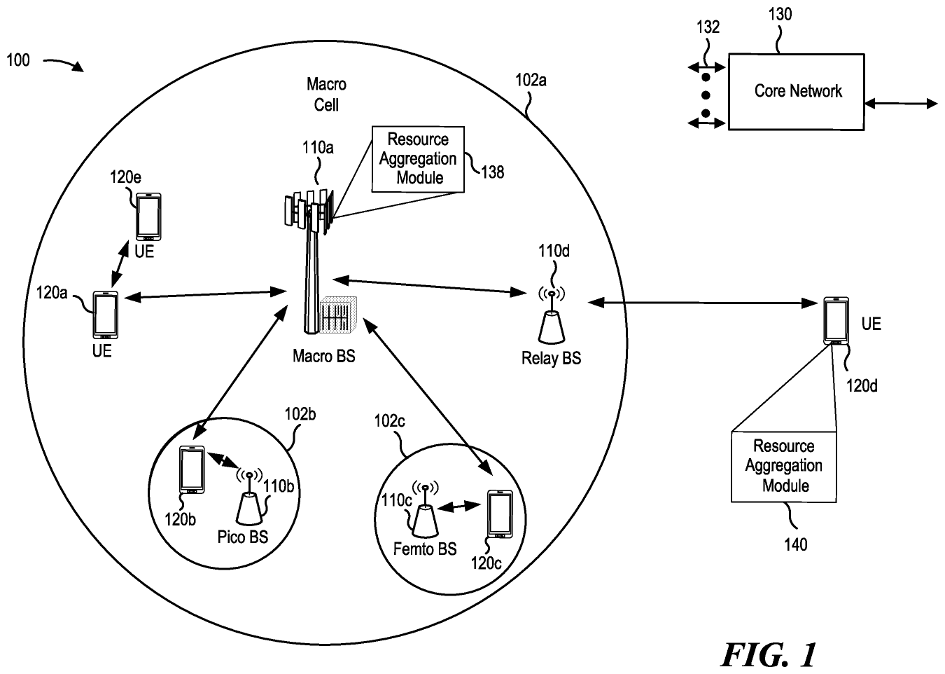

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (for example, macro BSs, pico BSs, femto BSs, relay BSs, and/or the like). These different types of BSs may have different transmit power levels, different coverage areas, and different impact on interference in the wireless network 100. For example, macro BSs may have a high transmit power level (for example, 5 to 40 watts) whereas pico BSs, femto BSs, and relay BSs may have lower transmit power levels (for example, 0.1 to 2 watts).

As an example, the BSs 110 (shown as BS 110a, BS 110b, BS 110c, and BS 110d) and the core network 130 may exchange communications via backhaul links 132 (for example, S1, etc.). Base stations 110 may communicate with one another over other backhaul links (for example, X2, etc.) either directly or indirectly (for example, through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (for example, S1, S2, etc.) and may perform radio configuration and scheduling for communications with the UEs 120. In some configurations, various functions of each access network entity or base station 110 may be distributed across various network devices (for example, radio heads and access network controllers) or consolidated into a single network device (for example, a base station 110).

UEs 120 (for example, 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (for example, a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

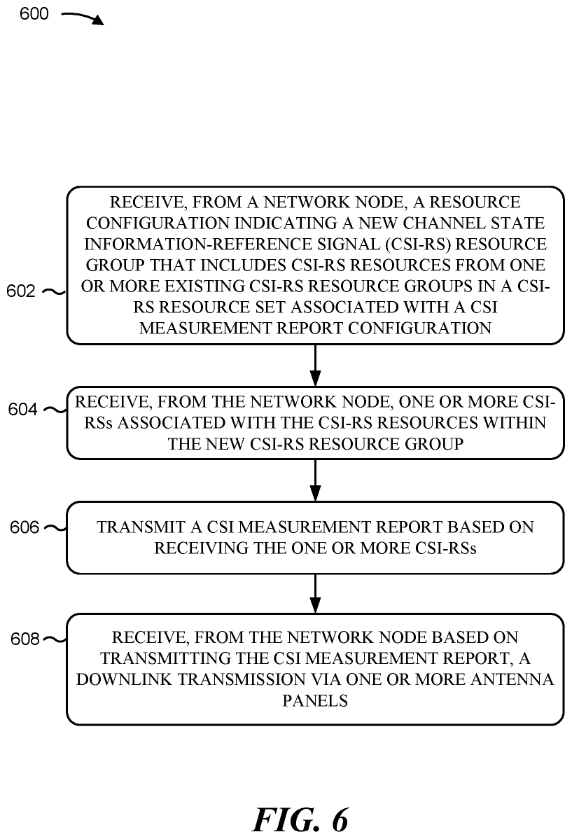

The UEs 120 may include a resource aggregation module 140. The resource aggregation module 140 may be configured to perform operations, including operations of the process 600 described below with reference to FIG. 6.

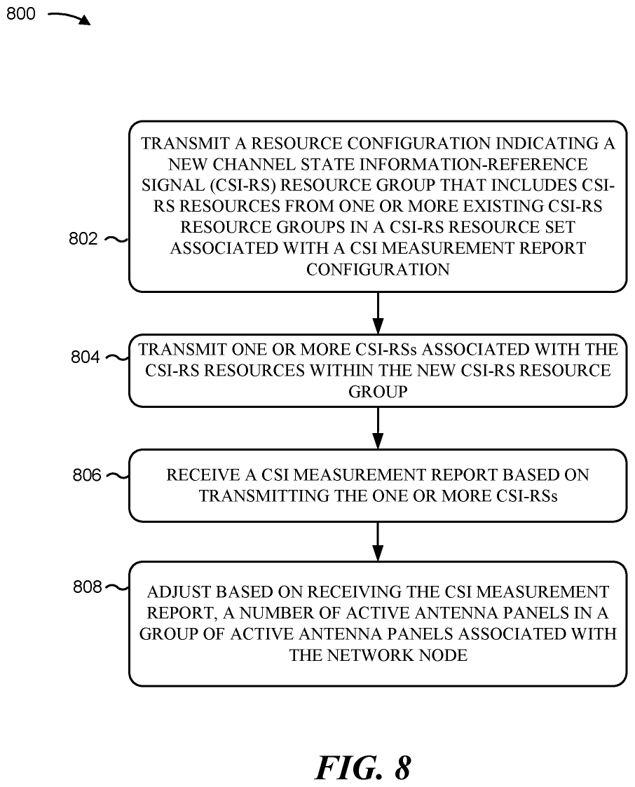

The core network 130 or the base stations 110 may include a resource aggregation module 138. The resource aggregation module 138 may be configured to perform operations, including operations of the process 800 described below with reference to FIG. 8.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (for example, remote device), or some other entity. A wireless node may provide, for example, connectivity for or to a network (for example, a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (for example, a system information block (SIB).

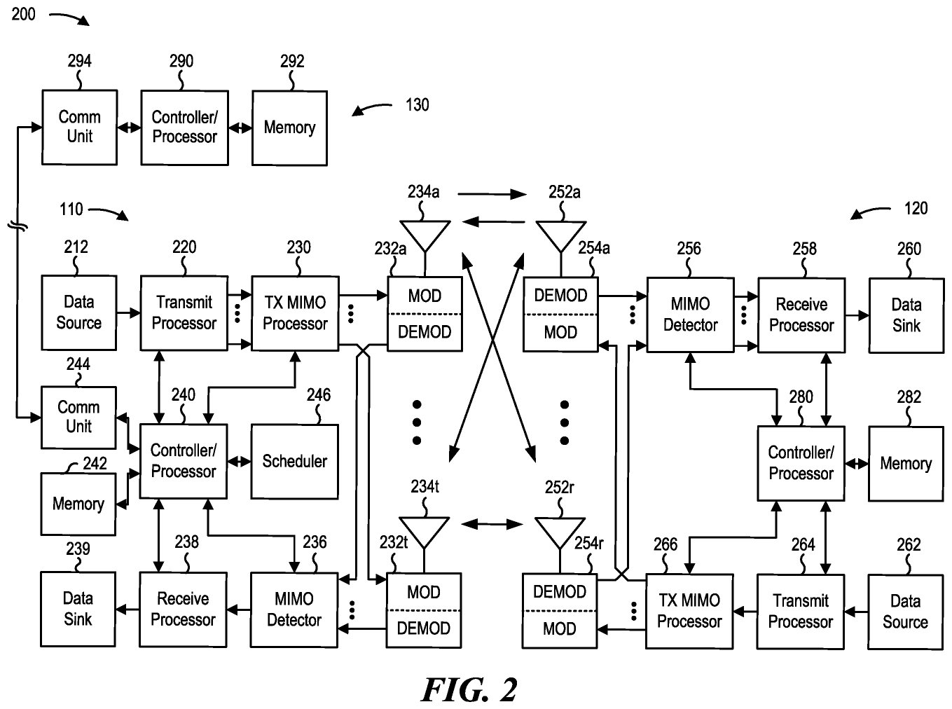

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (for example, for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example, for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with resource aggregation, as described in more detail elsewhere. For example, the controller/processor 240 of the base station 110, the controller/processor 280 of the UE 120, and/or any other component(s) of FIG. 2 may perform or direct operations of, for example, the processes of FIGS. 6 and 8 and/or other processes as described. Memories 242 and 282 may store data and program codes for the base station 110 and UE 120, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

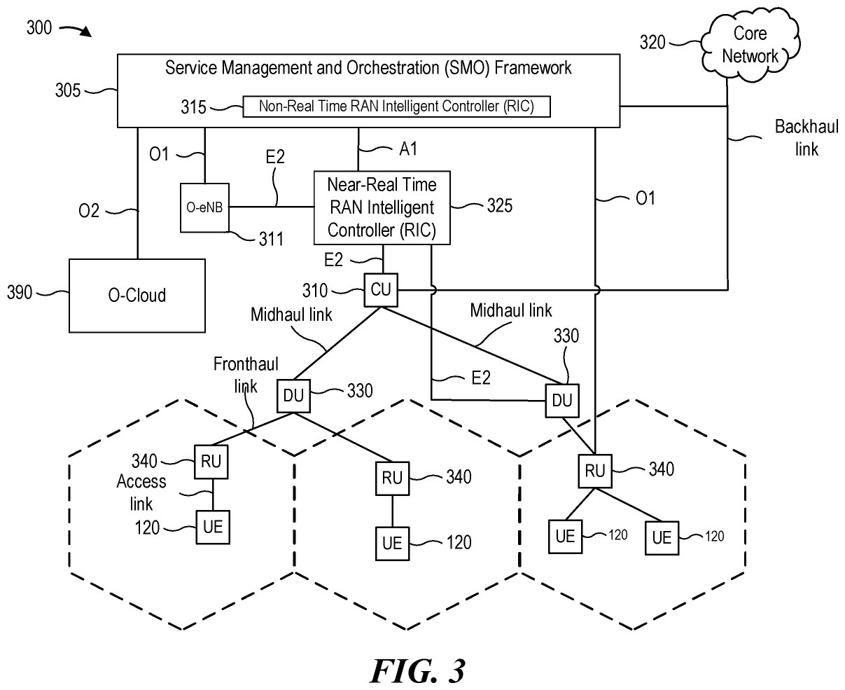

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (for example, the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) X11, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the Non-RT RIC 315 or the near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

Some networks may use massive-MIMO systems to improve network throughput and efficiency. In comparison to conventional MIMO systems, massive-MIMO systems increase a number of antennas at a network node. Specifically, a network node may include multiple co-located antenna panels, in which each antenna panel has multiple antenna ports. Additionally, each antenna panel may include a group of power amplifiers and an antenna subsystem. Therefore, massive-MIMO systems may increase power use at the network node. To improve (for example, decrease) power use, the network node may dynamically deactivate one or more antenna panels based on a cell load.

In some examples, the cell load may be determined based on a CSI report. The CSI may represent combined effects of, for example, one or more of scattering, fading, or power decay between a transmitter and receiver. Channel estimation using pilots, such as CSI-RSs, may be performed to determine these effects on the channel. CSI may be used to adapt transmissions based on the current channel conditions, which is useful for achieving reliable communication, in particular, with high data rates in massive-MIMO systems. CSI may be estimated at the receiver, quantized, and fed back to the transmitter.

A network node (for example, a base station 110), may configure UEs (for example, UEs 120) for CSI reporting. In some examples, the network node may configure the UE with one CSI report configuration or multiple CSI report configurations. The network node may provide the CSI report configuration to the UE via higher layer signaling, such as radio resource control (RRC) signaling for each bandwidth part. In such examples, the RRC signaling may indicate, for each resource set, a group of CSI-RS resources, where each CSI-RS resource includes multiple resource elements (for example, time and frequency resources). One or more of the resource elements may be mapped to a CSI-RS port. The CSI-RS resource elements may be zero power (ZP) or non-zero power (NZP) resources. One or more NZP CSI-RS resources may be configured for CM. For ease of explanation, each CSI-RS resource may be referred to as a CSI-RS resource group. Each CSI-RS resource group in the resource set include a same number of CSI-RS ports. The CSI-RS resource groups may be configured for CSI measurements, such as one or both of channel measurements or interference measurements. Specifically, the CSI-RS resource group may be associated with CSI-RS resources used for the channel measurement (for example, channel measurement resources (CMRs)) and CSI-RS resources the interference measurement (for example, interference measurement resources (IMRs)).

The CSI report configuration may also configure the CSI parameters to be reported using codebooks. Different types of codebooks may be defined. In some examples, the codebooks include Type I single panel or Type I multi-panel. In some other examples, the codebooks include Type I single panel, Type II port selection, and type II enhanced port selection. Regardless of which codebook is used, the CSI report may include one or more of a channel quality indicator (CQI), a precoding matrix indicator (PMI), a CSI-RS resource indicator (CRI), or a rank indicator (RI). The structure of the PMI may vary based on the codebook. In some examples, each codebook type and a corresponding number of CSI-RS antenna ports, per CSI-RS resource, may be associated with a specific configuration of antenna elements (N1, N2) and a number of antenna panels (Ng).

The CSI report configuration may configure the UE for aperiodic, periodic, or semi-persistent CSI reporting. For periodic CSI, the UE may be configured with periodic CSI-RS resources. Periodic CSI and semi-persistent CSI reporting on the physical uplink control channel (PUCCH) may be triggered via RRC signaling or a medium access control (MAC) control element (CE). For aperiodic and semi-persistent CSI on the physical uplink shared channel (PUSCH), the network node may signal the UE a CSI report trigger indicating for the UE to send a CSI report for one or more CSI-RS resources, or configuring the CSI-RS report trigger state. The CSI report trigger for aperiodic CSI and semi-persistent CSI on PUSCH may be provided via downlink control information (DCI). The CSI-RS trigger may be a signal that indicates, to the UE, that CSI-RSs will be transmitted for the CSI-RS resource.

The UE may report the CSI feedback, via a CSI measurement report, based on the CSI report configuration and the CSI report trigger. For example, the UE may measure the channel associated with CSI for the triggered CSI-RS resources. Based on the measurements, the UE may select one or more preferred CSI-RS resources or select a CSI-RS resource comprising one or more port groups. The UE may report the CSI feedback for one or more of the CSI-RS resources or port groups.

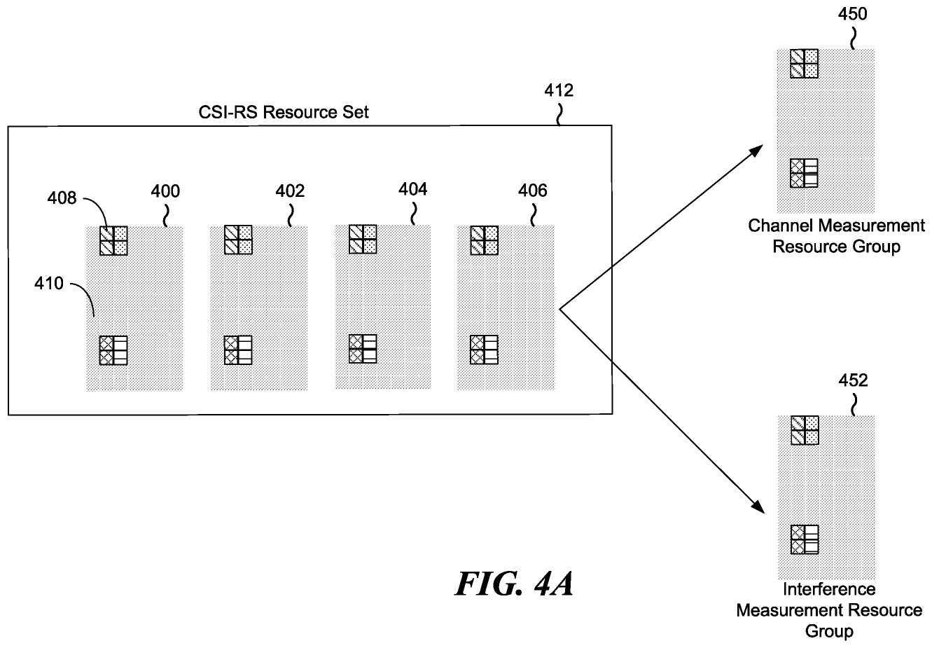

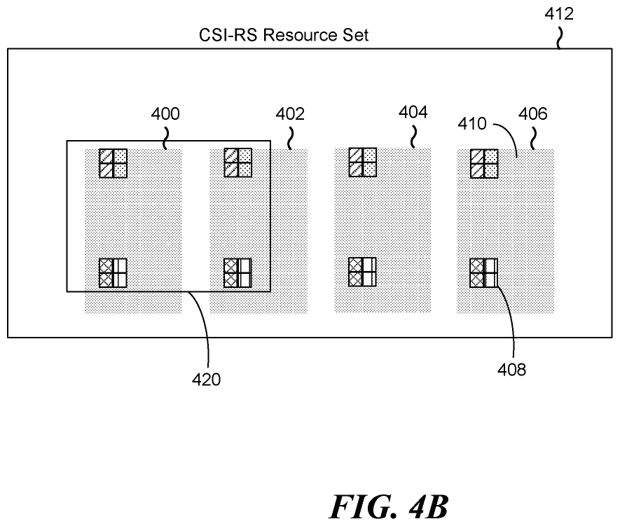

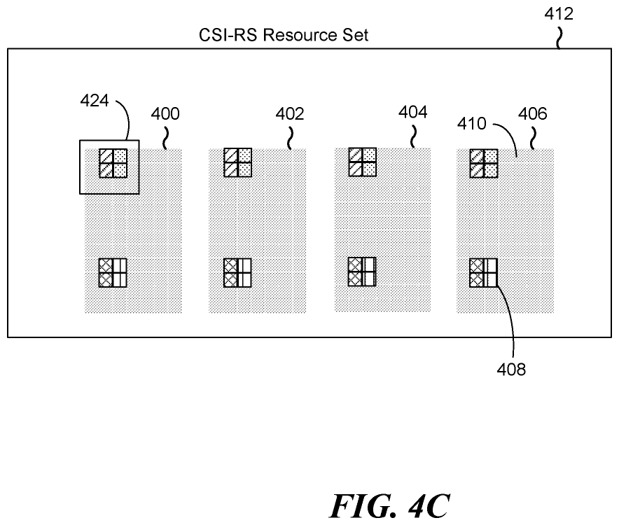

In some examples, resources from one or more CSI-RS resource groups configured via a CSI report configuration may be aggregated to form a new CSI-RS resource group. In some examples, the aggregated channel measurement resources may be associated with interference measurement resources. FIG. 4A is a block diagram illustrating an example of CSI-RS resource groups 400, 402, 404, and 406 associated with a CSI-RS resource set 412, in accordance with various aspects of the present disclosure. In the example of FIG. 4A, the CSI-RS resource groups 400, 402, 404, and 406 are associated with the CSI-RS resource set 412 configured via a CSI measurement report configuration, indicated to a UE via control signaling, such as RRC signaling. Each CSI-RS resource group 400, 402, 404, and 406 may include a group of CSI-RS resource elements 410. For brevity, only one resource element 410 is identified in FIGS. 4A, 4B, and 4C. The CSI-RS resource groups 400, 402, 404, and 406 may also be referred to as a CSI resource. Additionally, a group of CSI-RS ports may be defined within each CSI-RS resource group 400, 402, 404, and 406. In the example of FIG. 4A, each CSI-RS resource group 400, 402, 404, and 406 includes eight CSI-RS ports 408 (shown as a cross-hatched CSI-RS resources). For brevity, only one CSI-RS port 408 is identified in FIGS. 4A, 4B, and 4C. Additionally, as shown in the example of FIG. 4A, the fourth CSI-RS resource group 406 is associated with one channel measurement resource group 450 and one interference measurement resource group 452. For brevity, FIG. 4A only illustrates the channel measurement resource group 450 and the interference measurement resource group 452 associated with the fourth CSI-RS resource group 406. Still, each CSI-RS resource group 400, 402, 404, and 406 may be associated with a respective channel measurement resource group and a respective interference measurement resource group.

In some examples, a network node may transmit a resource configuration indicating a new CSI-RS resource group comprising CSI-RS resources 410 from one or more CSI-RS resource groups 400, 402, 404, and 406 in the CSI-RS resource set 412 associated with the CSI measurement report configuration. The new CSI-RS resource group may include a new group of CSI-RS ports comprising CSI-RS ports 408 associated with the one or more CSI-RS resource groups 400, 402, 404, and 406. In some examples, the new CSI-RS resource group may aggregate CSI-RS resources from two or more CSI-RS resource groups 400, 402, 404, and 406. In some other examples, the new CSI-RS resource group may be a subset of CSI-RS resources from one of the CSI-RS resource groups 400, 402, 404, and 406. The CSI-RS resource aggregation and reduction may be applied to one or both of channel measurement resources or interference measurement resources.

As discussed, in some examples, the new CSI-RS resource group may aggregate CSI-RS resources from two or more CSI-RS resource groups 400, 402, 404, and 406. An example of CSI-RS resource aggregation is provided in FIG. 4B, which is a block diagram illustrating a new CSI-RS resource group 420, in accordance with various aspects of the present disclosure. In the example of FIG. 4B, the new CSI-RS resource group 420 aggregates resources from a first CSI-RS resource group 400 and a second CSI-RS resource group 402. As shown in FIG. 4B, the new CSI-RS resource group 420 includes sixteen aggregated CSI-RS ports 408. In contrast, each CSI-RS resource group 400, 402, 404, and 406 includes eight CSI-RS ports 408. Therefore, a total number of CSI-RS ports 408 in the new CSI-RS resource group 420 is greater than a total number of CSI-RS ports 408 in both the first CSI-RS resource group 400 and the second CSI-RS resource group 402.

In some examples, the channel measurement resources aggregated from the first CSI-RS resource group 400 and the second CSI-RS resource group 402 may be configured with a same quasi-co location (QCL) source in a spatial domain (for example, a QCL-TypeD source). In such examples, the UE expects the aggregated channel measurement resources to have a same QCL-TypeD source. Aspects of the present disclosure are not limited to the aggregated resources having a same QCL-TypeD source, other QCL types may be the same.

In other examples, the aggregated channel measurement resources (for example, non-zero power channel measurement resources) have different QCL types. In some implementations, the UE does not expect the aggregated channel measurement resources to have the same QCL-TypeD source. In other implementations, the UE selects one QCL-TypeD source for the aggregated resources. The QCL-TypeD source may be associated with a reference channel measurement resource. In some examples, the reference channel measurement resource is a channel measurement resource with a lowest, or highest, resource ID (for example, NZP-CSI-RS-ResourceId) in a channel measurement resource set. In other examples, the reference channel measurement resource is a first, or last, channel measurement resource in the aggregated reference channel measurement resources. The channel measurement resources may be ordered in a resource list that is associated with the channel measurement resource set. Additionally, in some examples, the UE uses a same spatial receiving filter to receive one or both of the aggregated channel measurement resources or aggregated interference measurement resources.

As discussed, each CSI-RS resource group may include channel measurement resources and interference measurement resources. In some examples, interference measurement resources may be aggregated in a manner that is similar to the channel measurement resource aggregation. In one example, as shown in FIG. 4B, the new CSI-RS resource group 420 includes channel measurement resources that are aggregated from channel measurement resources with the first CSI-RS resource group 400 and the second CSI-RS resource group 402. In this example, similar to the channel measurement resource aggregation, the new CSI-RS resource group 420 includes interference measurement resources that are aggregated from interference measurement resources associated with the first CSI-RS resource group 400 and the second CSI-RS resource group 402. In other examples, the interference measurement resources are not aggregated. Rather, a reference interference measurement resource may be associated with the new CSI-RS resource group 420. The reference interference measurement resource may be the interference measurement resource associated with the reference channel measurement resource.

As discussed, in some examples, the new CSI-RS resource group 420 may be a subset of CSI-RS resources from one of the CSI-RS resource groups 400, 402, 404, and 406. The CSI-RS resource reduction may be applied to one or both of channel measurement resources or interference measurement resources. In some examples, the reduced channel measurement resources may be associated with interference measurement resources. An example of CSI-RS resource reduction is provided in FIG. 4C, which is a block diagram illustrating a new CSI-RS resource group 424, in accordance with various aspects of the present disclosure. In the example of FIG. 4C, the new CSI-RS resource group 424 includes four aggregated CSI-RS ports 408. In contrast, the first CSI-RS resource group 400 includes eight CSI-RS ports 408. Therefore, a total number of CSI-RS ports 408 in the new group of CSI-RS resource group 424 is less than a total number of CSI-RS ports 408 in the first CSI-RS resource group 400. As such, the new CSI-RS resource group 424 includes a subset of CSI-RS ports 408 associated with the first CSI-RS resource group 400.

In some examples, when the new CSI-RS resource group 424 is associated with a reduced number of CSI-RS resources, the interference measurement resources may be reduced in a manner that is similar to the reduction of the channel measurement resources. In one such example, if a reduced channel measurement resource is a first code-division multiplexing group of the first CSI-RS resource group 400, the interference measurement resources associated with the reduced channel measurement resources is the first code-division multiplexing group of the interference measurement resources associated with the first CSI-RS resource group 400.

In other examples, when the new CSI-RS resource group 424 is associated with a reduced number of CSI-RS resources from the first CSI-RS resource group 400, the interference measurement resources associated with the reduced channel measurement resources may be the same as the interference measurement resources associated with the first CSI-RS resource group 400. As an example, the reduced channel measurement resources associated with the new CSI-RS resource group 424 may be selected from a first code-division multiplexing group associated with the first CSI-RS resource group 400. In this example, the interference measurement resources associated with the reduced channel measurement resources may be the same as the interference measurement resources associated with the first CSI-RS resource group 400.

In some implementations, a network node may adjust a number of active antenna panels from a group of active antenna panels based on a CSI measurement report that is received from a UE based on the new CSI-RS resource group 420 or 424. In some examples, the network node may maintain an active state of each active antenna panel associated with the new group of CSI-RS ports in the new CSI-RS resource group 420 or 424 based on the CSI measurement report indicating a cell load satisfies a load condition. In such examples, the network node may deactivate one or more antenna panels of the group of active antenna panels based on the CSI measurement report indicating a cell load satisfies a load condition. Each of the deactivated antenna panels is not associated with the new group of CSI-RS ports. The load condition may be satisfied based on the cell load being equal to or less than a load threshold.

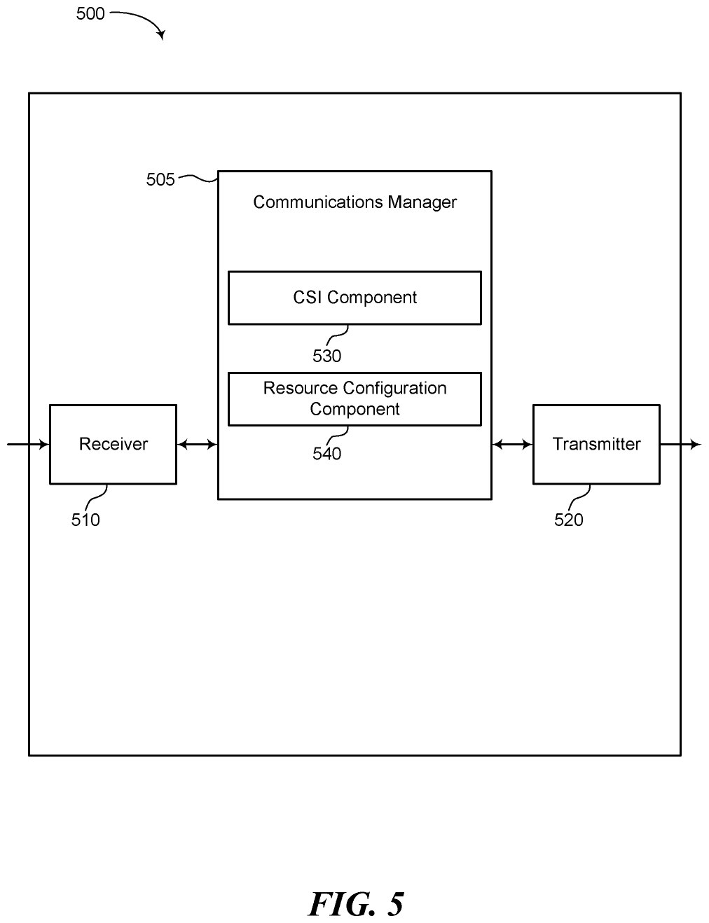

FIG. 5 is a block diagram illustrating an example wireless communication device that supports forming a new CSI-RS resource group, in accordance with some aspects of the present disclosure. The device 500 may be an example of aspects of a UE 120 described with reference to FIGS. 1, 2, and 3. The wireless communications device 500 may include a receiver 510, a communications manager 505, a transmitter 520, a CSI component 530, and a resource configuration component 540, which may be in communication with one another (for example, via one or more buses). In some examples, the wireless communications device 500 is configured to perform operations, including operations of the process 600 described below with reference to FIG. 6.

In some examples, the wireless communications device 500 can include a chip, chipset, package, or device that includes at least one processor and at least one modem (for example, a 5G modem or other cellular modem). In some examples, the communications manager 505, or its sub-components, may be separate and distinct components. In some examples, at least some components of the communications manager 505 are implemented at least in part as software stored in a memory. For example, portions of one or more of the components of the communications manager 505 can be implemented as non-transitory code executable by the processor to perform the functions or operations of the respective component.

The receiver 510 may receive one or more of reference signals (for example, periodically configured channel state information reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communications devices via various channels including control channels (for example, a physical downlink control channel (PDCCH), physical uplink control channel (PUCCH), or physical sidelink control channel PSCCH) and data channels (for example, a physical downlink shared channel (PDSCH), physical sidelink shared channel (PSSCH), a physical uplink shared channel (PUSCH)). The other wireless communications devices may include, but are not limited to, a base station 110 described with reference to FIGS. 1 and 2, a DU 330 described with reference to FIG. 3, or a CU 310 described with reference to FIG. 3.

The received information may be passed on to other components of the device 500. The receiver 510 may be an example of aspects of the receive processor 256 described with reference to FIG. 2. The receiver 510 may include a set of radio frequency (RF) chains that are coupled with or otherwise utilize a set of antennas (for example, the set of antennas may be an example of aspects of the antennas 252 described with reference to FIG. 2).

The transmitter 520 may transmit signals generated by the communications manager 505 or other components of the wireless communications device 500. In some examples, the transmitter 520 may be collocated with the receiver 510 in a transceiver. The transmitter 520 may be an example of aspects of the transmit processor 268 described with reference to FIG. 2. The transmitter 520 may be coupled with or otherwise utilize a set of antennas (for example, the set of antennas may be an example of aspects of the antennas 252 described with reference to FIG. 2), which may be antenna elements shared with the receiver 510. In some examples, the transmitter 520 is configured to transmit control information in a PUCCH, PSCCH, or PDCCH and data in a physical uplink shared channel (PUSCH), PSSCH, or PDSCH.

The communications manager 505 may be an example of aspects of the controller/processor 259 described with reference to FIG. 2. The communications manager 505 may include the CSI component 530 and the resource configuration component 540. In some examples, working in conjunction with the receiver 510, the resource configuration component 540 may receive, from a network node, a resource configuration indicating a new CSI-RS resource group that includes CSI-RS resources from one or more existing CSI-RS resource groups in a CSI-RS resource set associated with a CSI measurement report configuration. The new CSI-RS resource group may be associated with a new group of CSI-RS ports that includes CSI-RS ports associated with the one or more existing CSI-RS resource groups. Furthermore, working in conjunction with the receiver 510 and the resource configuration component 540, the CSI component 530 may receive, from the network node, one or more CSI-RSs associated with the CSI-RS resources within the new CSI-RS resource group. Additionally, working in conjunction with the transmitter, the 520, the CSI component 530 may transmit a CSI measurement report based on receiving the one or more CSI-RSs. Finally, working in conjunction with the receiver 530, the CSI component 530 may receive, from the network node based on transmitting the CSI measurement report, a downlink transmission via one or more antenna panels, a quantity of the one or more antenna panels being based on a cell load indicated in the CSI measurement report.

FIG. 6 is a flow diagram illustrating an example process 600 performed by a UE, in accordance with some aspects of the present disclosure. The UE may be an example of a UE 120 described with reference to FIGS. 1, 2, and 3. The example process 600 is an example of forming a new CSI-RS resource group. As shown in FIG. 6, the process 600 begins at block 602 by receiving, from a network node, a resource configuration indicating a new CSI-RS resource group that includes CSI-RS resources from one or more existing CSI-RS resource groups in a CSI-RS resource set associated with a CSI measurement report configuration. The new CSI-RS resource group may be associated with a new group of CSI-RS ports that includes CSI-RS ports associated with the one or more existing CSI-RS resource groups. At block 604, the process 600 receives, from the network node, one or more CSI-RSs associated with the CSI-RS resources within the new CSI-RS resource group. At block 606, the process 600 transmits a CSI measurement report based on receiving the one or more CSI-RSs. At block 608, the process 600 receives, from the network node based on transmitting the CSI measurement report, a downlink transmission via one or more antenna panels. A quantity of the one or more antenna panels may be based on a cell load indicated in the CSI measurement report.

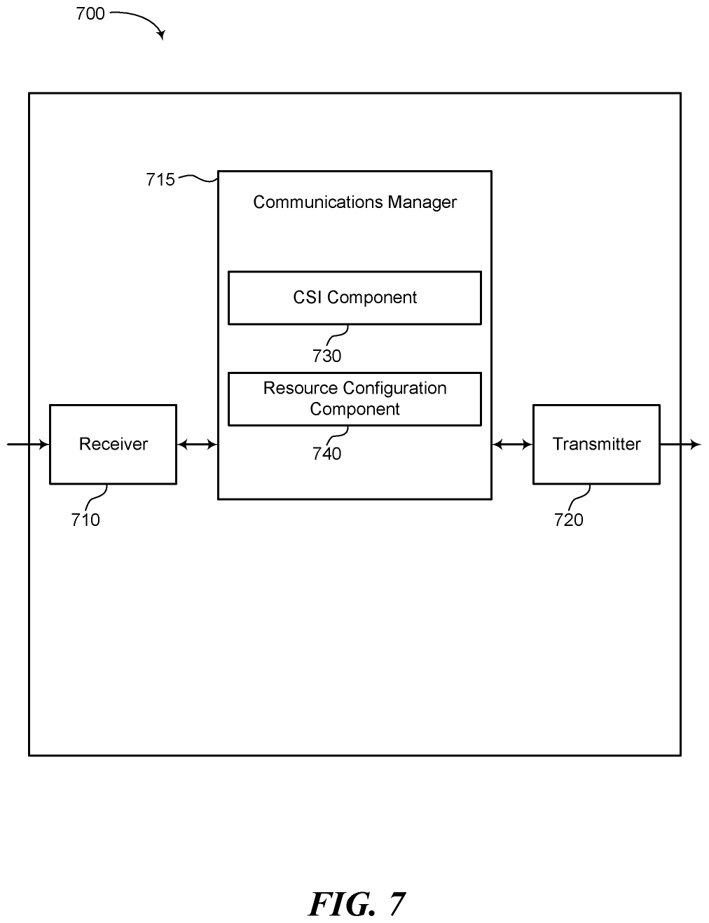

FIG. 7 is a block diagram illustrating an example wireless communication device 700 that supports forming a new CSI-RS resource group, in accordance with aspects of the present disclosure. The wireless communication device 700 may be an example of a base station 110 described with reference to FIGS. 1 and 2, a DU 330 described with reference to FIG. 3, or a CU 310 described with reference to FIG. 3. The wireless communication device 700 may include a receiver 710, a communications manager 715, a CSI component 730, a resource configuration component 740, and a transmitter 720, which may be in communication with one another (for example, via one or more buses). In some examples, the wireless communication device 700 is configured to perform operations, including operations of the process 800 described below with reference to FIG. 8.

In some examples, the wireless communication device 700 can include a chip, system on chip (SOC), chipset, package, or device that includes at least one processor and at least one modem (for example, a 5G modem or other cellular modem). In some examples, the communications manager 715, or its sub-components, may be separate and distinct components. In some examples, at least some components of the communications manager 715 are implemented at least in part as software stored in a memory. For example, portions of one or more of the components of the communications manager 715 can be implemented as non-transitory code executable by the processor to perform the functions or operations of the respective component.

The receiver 710 may receive one or more reference signals (for example, periodically configured CSI-RSs, aperiodically configured CSI-RSs, or multi-beam-specific reference signals), synchronization signals (for example, synchronization signal blocks (SSBs)), control information, and/or data information, such as in the form of packets, from one or more other wireless communication devices via various channels including control channels (for example, a PUCCH or a PSCCH) and data channels (for example, a PUSCH or a PSSCH). The other wireless communication devices may include, but are not limited to, a UE 120, described with reference to FIGS. 1, 2, and 3.

The received information may be passed on to other components of the wireless communication device 700. The receiver 710 may be an example of aspects of the receive processor 270 described with reference to FIG. 2. The receiver 710 may include a set of radio frequency (RF) chains that are coupled with or otherwise utilize a set of antennas (for example, the set of antennas may be an example of aspects of the antennas 234 described with reference to FIG. 2).

The transmitter 720 may transmit signals generated by the communications manager 715 or other components of the wireless communication device 700. In some examples, the transmitter 720 may be collocated with the receiver 710 in a transceiver. The transmitter 720 may be an example of aspects of the transmit processor 216 described with reference to FIG. 2. The transmitter 720 may be coupled with or otherwise utilize a set of antennas (for example, the set of antennas may be an example of aspects of the antennas 252), which may be antenna elements shared with the receiver 710. In some examples, the transmitter 720 is configured to transmit control information in a PDCCH or a PSCCH and data in a PDSCH or PSSCH.

The communications manager 715 may be an example of aspects of the controller/processor 275 described with reference to FIG. 2. The communications manager 715 includes the CSI component 730 and the resource configuration component 740. In some examples, working in conjunction with the transmitter 720, the resource configuration component 740 may transmit a resource configuration indicating a new CSI-RS resource group that includes CSI-RS resources from one or more existing CSI-RS resource groups in a CSI-RS resource set associated with a CSI measurement report configuration. The new CSI-RS resource group may be associated with a new group of CSI-RS ports that includes CSI-RS ports associated with the one or more existing CSI-RS resource groups. Additionally, working in conjunction with one or both of the transmitter 720 or the resource configuration component 740, the CSI component 730 may transmit one or more CSI-RSs associated with the CSI-RS resources within the new CSI-RS resource group. Furthermore, working in conjunction with the receiver 710, the CSI component 730 may receive a CSI measurement report based on transmitting the one or more CSI-RSs. Finally, working in conjunction with the CSI component 730 may adjust, based on receiving the CSI measurement report, a number of active antenna panels in a group of active antenna panels may be associated with the network node.

FIG. 8 is a flow diagram illustrating an example of a process 800 performed by a wireless device, in accordance with some aspects of the present disclosure. The wireless device may be an example of a base station 110 described with reference to FIGS. 1 and 2, a DU 330 described with reference to FIG. 3, or a CU 310 described with reference to FIG. 3. The example process 800 is an example of reconfiguring special slots. As shown in FIG. 8, the process 800 begins at block 802, by transmitting a resource configuration indicating a new CSI-RS resource group that includes CSI-RS resources from one or more existing CSI-RS resource groups in a CSI-RS resource set associated with a CSI measurement report configuration. The new CSI-RS resource group may be associated with a new group of CSI-RS ports that includes CSI-RS ports associated with the one or more existing CSI-RS resource groups. At block 804, the process 800 transmits one or more CSI-RSs associated with the CSI-RS resources within the new CSI-RS resource group. At block 806, the process 800 receives a CSI measurement report based on transmitting the one or more CSI-RSs. At block 808, the process 800 adjusts, based on receiving the CSI measurement report. A number of active antenna panels in a group of active antenna panels may be associated with the network node.

Implementation examples are described in the following numbered clauses:
Clause 1. A method for wireless communication by a network node, comprising: transmitting a resource configuration indicating a new CSI-RS resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more existing CSI-RS resource groups; transmitting one or more CSI-RSs associated with the CSI-RS resources within the new CSI-RS resource group; receiving a CSI measurement report based on transmitting the one or more CSI-RSs; and adjusting, based on receiving the CSI measurement report, a number of active antenna panels in a group of active antenna panels associated with the network node.
Clause 2. The method of Clause 1, wherein one or more active antenna panels from the group of active antenna panels are associated with the new group of CSI-RS ports.
Clause 3. The method of Clause 2, wherein adjusting the number of active antenna panels comprises: maintaining an active state of each of the one or more active antenna panels associated with the new group of CSI-RS ports based on the CSI measurement report indicating that a cell load satisfies a load condition; and disabling each active antenna panel of the group of active antenna panels that is not associated with the new group of CSI-RS ports based on the CSI measurement report indicating that the cell load satisfies the load condition.
Clause 4. The method of any one of Clauses 1-3, wherein: the new CSI-RS resource group includes the CSI-RS resources aggregated from two or more CSI-RS resource groups; and a number of CSI-RS ports in the new group of CSI-RS ports is equal to a total number of CSI-RS ports associated with each CSI-RS resource group of the two or more CSI-RS resource groups.
Clause 5. The method of Clause 4, wherein the CSI-RS resources aggregated from the two or more CSI-RS resource groups are associated with a same QCL source in a spatial domain.
Clause 6. The method of Clause 4, wherein: each CSI-RS resource group is a NZP CMR group; and each NZP CMR group is associated with a different QCL source in a spatial domain.
Clause 7. The method of any one of Clauses 1-6, wherein each CSI-RS resource group includes a CMR group and an IMR group.
Clause 8. The method of any of Clauses 1-3 or 7, wherein: the new CSI-RS resource group includes a subset of CSI-RS resources from one CSI-RS resource group; and a number of CSI-RS ports in the new group of CSI-RS ports is less than a total number of CSI-RS ports associated with the one CSI-RS resource group.
Clause 9. The method of Clause 8, wherein: the subset of CSI-RS resources includes a subset of CMRs from a CMR group associated with the one CSI-RS resource group and a subset of IMRs from an IMR group associated with the one CSI-RS resource group; and the subset of CMRs and the subset of IMRs are associated with a same CDM group.
Clause 10. The method of Clause 8, wherein: the subset of CSI-RS resources includes resources associated with a subset of CMRs from a CMR group associated with the one CSI-RS resource group; the subset of CMRs are associated with one CDM group of two or more CDM groups associated with the CMR group; and the new CSI-RS resource group further includes resources of an IMR group associated with the one CSI-RS resource group.
Clause 11. A method for wireless communication by a UE, comprising: receiving, from a network node, a resource configuration indicating a new CSI-RS resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more CSI-RS resource groups; receiving, from the network node, one or more CSI-RSs associated with the CSI-RS resources within the new CSI-RS resource group; transmitting a CSI measurement report based on receiving the one or more CSI-RSs; and receiving, from the network node based on transmitting the CSI measurement report, a downlink transmission via one or more antenna panels, a quantity of the one or more antenna panels being based on a cell load indicated in the CSI measurement report.
Clause 12. The method of Clause 11, wherein: the new CSI-RS resource group includes the CSI-RS resources aggregated from two or more CSI-RS resource groups; and a number of CSI-RS ports in the new group of CSI-RS ports is equal to a total number of CSI-RS ports in the two or more CSI-RS resource groups.
Clause 13. The method of Clause 12, wherein the CSI-RS resources aggregated from the two or more CSI-RS resource groups are associated with a same QCL source in a spatial domain.
Clause 14. The method of Clause 12, wherein: each CSI-RS resource group of the two or more CSI-RS resource groups includes an IMR group and a CMR group; and
   the CSI-RS resources are aggregated from one or both of a respective IMR group or a respective CMR group associated with each CSI-RS resource group of the two or more CSI-RS resource groups.
Clause 15. The method of Clause 14, wherein: the CSI-RS resources are aggregated from each CMR group associated with a respective CSI-RS resource group of the two or more CSI-RS resource groups; each CMR group is a NZP CMR group; and each NZP CMR group associated with a respective CSI-RS resource group of the two or more CSI-RS resource groups is associated with a different QCL source in a spatial domain.
Clause 16. The method of Clause 15, further comprising selecting one QCL source in the spatial domain for the CSI-RS resources aggregated from each NZP CMR group, wherein the one QCL source is associated with one NZP CMR group associated with one CSI-RS resource group of the two or more CSI-RS resource groups.
Clause 17. The method of Clause 16, wherein the one NZP CMR group is associated with a first resource ID in a CMR set associated with the CSI measurement report configuration or a last resource ID in the CMR set.
Clause 18. The method of Clause 16, wherein the one NZP CMR group is associated with a first position in a resource list associated with a CMR set or a last position in the resource list.
Clause 19. The method of Clause 16, wherein the new CSI-RS resource group includes a reference IMR that is associated with the one NZP CMR group.
Clause 20. The method of Clause 14, wherein the CSI-RS resources are aggregated from both the respective IMR group and the respective CMR group associated with each CSI-RS resource group of the two or more CSI-RS resource groups.
Clause 21. The method of Clause 11, wherein: the new CSI-RS resource group includes a subset of CSI-RS resources from one CSI-RS resource group; and a number of CSI-RS ports in the new group of CSI-RS ports is less than a total number of CSI-RS ports in the one CSI-RS resource group.
Clause 22. The method of Clause 21, wherein: the subset of CSI-RS resources includes a subset of CMRs from a CMR group associated with the one CSI-RS resource group and a subset of IMRs from an IMR group associated with the one CSI-RS resource group; and the subset of CMRs and the subset of IMRs are associated with a same CDM group.
Clause 23. The method of Clause 21, wherein: the subset of CSI-RS resources includes resources associated with a subset of CMRs from a CMR group associated with the one CSI-RS resource group; the subset of CMRs are associated with one CDM group of two or more CDM groups associated with the CMR group; and the new CSI-RS resource group further includes resources of an IMR group associated with the one CSI-RS resource group.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

1. A method for wireless communication by a user equipment (UE), comprising:
receiving, from a network node, a resource configuration indicating a new channel state information-reference signal (CSI-RS) resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more existing CSI-RS resource groups;
receiving, from the network node, one or more CSI-RSs associated with the CSI-RS resources within the new CSI-RS resource group;
transmitting a CSI measurement report based on receiving the one or more CSI-RSs; and
receiving, from the network node based on transmitting the CSI measurement report, a downlink transmission via one or more antenna panels, a quantity of the one or more antenna panels being based on a cell load indicated in the CSI measurement report.

2. The method of claim 1, wherein:
the new CSI-RS resource group includes the CSI-RS resources aggregated from two or more CSI-RS resource groups; and
a number of CSI-RS ports in the new group of CSI-RS ports is equal to a total number of CSI-RS ports in the two or more CSI-RS resource groups.

3. The method of claim 2, wherein the CSI-RS resources aggregated from the two or more CSI-RS resource groups are associated with a same quasi-co location (QCL) source in a spatial domain.

4. The method of claim 2, wherein:
each CSI-RS resource group of the two or more CSI-RS resource groups includes an interference measurement resource (IMR) group and a channel measurement resource (CMR) group; and
the CSI-RS resources are aggregated from one or both of a respective IMR group or a respective CMR group associated with each CSI-RS resource group of the two or more CSI-RS resource groups.

5. The method of claim 4, wherein:
the CSI-RS resources are aggregated from each CMR group associated with a respective CSI-RS resource group of the two or more CSI-RS resource groups;
each CMR group is a non-zero power (NZP) CMR group; and
each NZP CMR group associated with a respective CSI-RS resource group of the two or more CSI-RS resource groups is associated with a different quasi-co location (QCL) source in a spatial domain.

6. The method of claim 5, further comprising selecting one QCL source in the spatial domain for the CSI-RS resources aggregated from each NZP CMR group,
wherein the one QCL source is associated with one NZP CMR group associated with one CSI-RS resource group of the two or more CSI-RS resource groups.

7. The method of claim 6, wherein the one NZP CMR group is associated with a first resource ID in a CMR set associated with the CSI measurement report configuration or a last resource ID in the CMR set.

8. The method of claim 6, wherein the one NZP CMR group is associated with a first position in a resource list associated with a CMR set or a last position in the resource list.

9. The method of claim 6, wherein the new CSI-RS resource group includes a reference IMR that is associated with the one NZP CMR group.

10. The method of claim 4, wherein the CSI-RS resources are aggregated from both the respective IMR group and the respective CMR group associated with each CSI-RS resource group of the two or more CSI-RS resource groups.

11. The method of claim 1, wherein:
the new CSI-RS resource group includes a subset of CSI-RS resources from one CSI-RS resource group; and
a number of CSI-RS ports in the new group of CSI-RS ports is less than a total number of CSI-RS ports in the one CSI-RS resource group.

12. The method of claim 11, wherein:
the subset of CSI-RS resources includes a subset of channel measurement resources (CMRs) from a CMR group associated with the one CSI-RS resource group and a subset of interference measurement resources (IMRs) from an IMR group associated with the one CSI-RS resource group; and
the subset of CMRs and the subset of IMRs are associated with a same code division multiplexing (CDM) group.

13. The method of claim 11, wherein:
the subset of CSI-RS resources includes resources associated with a subset of channel measurement resources (CMRs) from a CMR group associated with the one CSI-RS resource group;
the subset of CMRs are associated with one code division multiplexing (CDM) group of two or more CDM groups associated with the CMR group; and
the new CSI-RS resource group further includes resources of an interference measurement resource (IMR) group associated with the one CSI-RS resource group.

14. An apparatus for wireless communications at a user equipment (UE), comprising:
a processor; and
a memory coupled with the processor and storing instructions operable, when executed by the processor, to cause the apparatus to:
receive, from a network node, a resource configuration indicating a new channel state information-reference signal (CSI-RS) resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more existing CSI-RS resource groups;
receive, from the network node, one or more CSI-RSs associated with the CSI-RS resources within the new CSI-RS resource group;
transmit a CSI measurement report based on receiving the one or more CSI-RSs; and
receive, from the network node based on transmitting the CSI measurement report, a downlink transmission via one or more antenna panels, a quantity of the one or more antenna panels being based on a cell load indicated in the CSI measurement report.

15. The apparatus of claim 14, wherein:
the new CSI-RS resource group includes the CSI-RS resources aggregated from two or more CSI-RS resource groups; and
a number of CSI-RS ports in the new group of CSI-RS ports is equal to a total number of CSI-RS ports in the two or more CSI-RS resource groups.

16. The apparatus of claim 14, wherein:
the new CSI-RS resource group includes a subset of CSI-RS resources from one CSI-RS resource group; and
a number of CSI-RS ports in the new group of CSI-RS ports is less than a total number of CSI-RS ports in the one CSI-RS resource group.

17. The apparatus of claim 14, wherein each existing CSI-RS resource group includes an interference measurement resource (IMR) group and a channel measurement resource (CMR) group.

18. A method for wireless communication by a network node, comprising:
transmitting a resource configuration indicating a new channel state information-reference signal (CSI-RS) resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more existing CSI-RS resource groups;
transmitting one or more CSI-RSs associated with the CSI-RS resources within the new CSI-RS resource group;
receiving a CSI measurement report based on transmitting the one or more CSI-RSs; and
adjusting, based on receiving the CSI measurement report, a number of active antenna panels in a group of active antenna panels associated with the network node.

19. The method of claim 18, wherein one or more active antenna panels from the group of active antenna panels are associated with the new group of CSI-RS ports.

20. The method of claim 19, wherein adjusting the number of active antenna panels comprises:
maintaining an active state of each of the one or more active antenna panels associated with the new group of CSI-RS ports based on the CSI measurement report indicating that a cell load satisfies a load condition; and
disabling each active antenna panel of the group of active antenna panels that is not associated with the new group of CSI-RS ports based on the CSI measurement report indicating that the cell load satisfies the load condition.

21. The method of claim 18, wherein:
the new CSI-RS resource group includes the CSI-RS resources aggregated from two or more CSI-RS resource groups; and
a number of CSI-RS ports in the new group of CSI-RS ports is equal to a total number of CSI-RS ports associated with each CSI-RS resource group of the two or more CSI-RS resource groups.

22. The method of claim 21, wherein the CSI-RS resources aggregated from the two or more CSI-RS resource groups are associated with a same quasi-co location (QCL) source in a spatial domain.

23. The method of claim 21, wherein:
each CSI-RS resource group is a non-zero power (NZP) channel measurement resource (CMR) group; and
each NZP CMR group is associated with a different QCL source in a spatial domain.

24. The method of claim 21, wherein each CSI-RS resource group includes a channel measurement resource (CMR) group and an interference measurement resource (IMR) group.

25. The method of claim 18, wherein:
the new CSI-RS resource group includes a subset of CSI-RS resources from one CSI-RS resource group; and
a number of CSI-RS ports in the new group of CSI-RS ports is less than a total number of CSI-RS ports associated with the one CSI-RS resource group.

26. The method of claim 25, wherein:
the subset of CSI-RS resources includes a subset of channel measurement resources (CMRs) from a CMR group associated with the one CSI-RS resource group and a subset of interference measurement resources (IMRs) from an IMR group associated with the one CSI-RS resource group; and
the subset of CMRs and the subset of IMRs are associated with a same code division multiplexing (CDM) group.

27. The method of claim 25, wherein:
the subset of CSI-RS resources includes resources associated with a subset of channel measurement resources (CMRs) from a CMR group associated with the one CSI-RS resource group;
the subset of CMRs are associated with one code division multiplexing (CDM) group of two or more CDM groups associated with the CMR group; and
the new CSI-RS resource group further includes resources of an interference measurement resource (IMR) group associated with the one CSI-RS resource group.

28. An apparatus for wireless communication by a network node, comprising:
a processor; and
a memory coupled with the processor and storing instructions operable, when executed by the processor, to cause the apparatus:
transmit a resource configuration indicating a new channel state information-reference signal (CSI-RS) resource group that includes CSI-RS resources from one or more existing CSI-RS resource groups in a CSI-RS resource set associated with a CSI measurement report configuration, the new CSI-RS resource group being associated with a new group of CSI-RS ports that includes CSI-RS ports associated with the one or more existing CSI-RS resource groups;
transmit one or more CSI-RSs associated with the CSI-RS resources within the new CSI-RS resource group;
receive a CSI measurement report based on transmitting the one or more CSI-RSs; and
adjust, based on receiving the CSI measurement report, a number of active antenna panels in a group of active antenna panels associated with the network node.

29. The apparatus of claim 28, wherein:
the new CSI-RS resource group includes the CSI-RS resources aggregated from two or more CSI-RS resource groups; and
a number of CSI-RS ports in the new group of CSI-RS ports is equal to a total number of CSI-RS ports associated with each CSI-RS resource group of the two or more CSI-RS resource groups.

30. The apparatus of claim 28, wherein:
the new CSI-RS resource group includes a subset of CSI-RS resources from one CSI-RS resource group; and
a number of CSI-RS ports in the new group of CSI-RS ports is less than a total number of CSI-RS ports associated with the one CSI-RS resource group.
